(19) United States
(12) Patent Application Publication
(10) Pub. No.: US 2025/0303331 A1
(43) Pub. Date: Oct. 2, 2025

(54) AIR FILTER DEVICE OF A MOTOR VEHICLE

(71) Applicant: MAHLE International GmbH, Stuttgart (DE)

(72) Inventor: Alexandru Roi, Timisoara (RO)

(21) Appl. No.: 19/091,785

(22) Filed: Mar. 26, 2025

(30) Foreign Application Priority Data
Mar. 27, 2024 (DE) 102024108853.2

(51) Int. Cl. B01D 46/00

(52) U.S. Cl. CPC B01D 46/0002; B01D 2265/028; B01D 2279/40

(57) ABSTRACT

An air filter system of a motor vehicle may include a housing and a cover. The housing may include i) a housing interior for receiving an air filter element and ii) a housing base body. The cover may be detachably fastened to the housing base body. The housing base body may include i) at least two air inlet openings through which raw air to be filtered is flowable into the housing interior and ii) an air outlet opening through which filtered, clean air is flowable out of the housing interior. At least one air inlet opening of the at least two air inlet openings may be closable via the cover.

### CROSS-REFERENCE TO RELATED APPLICATION

This application claims priority to German Patent Application No. DE102024108853.2, filed on Mar. 27, 2024, the contents of which is hereby incorporated by reference in its entirety.

### TECHNICAL FIELD

The present invention relates to an air filter system for a motor vehicle, which is configured, for example, to filter air for an internal combustion engine or for a fuel cell system of the motor vehicle.

In the present context, a “configuration” corresponds to an “arrangement” and/or a “device”, so that the phrase “configured such that” is synonymous with the phrase “configured such that” and/or “set up such that”.

### BACKGROUND

Typically, such an air filter system has a housing with an interior space for receiving an air filter element for filtering the air. The housing is equipped with an air inlet opening through which the raw air to be filtered can flow into the housing interior, and with an air outlet opening through which the filtered clean air can flow out of the housing interior.

An air filter system is configured for the respective vehicle with regard to a predetermined air mass flow or fresh air requirement that may arise during the operation of the vehicle and is to be filtered with the help of the air filter system. For vehicles that differ from one another in terms of their various air mass flows—for example, due to different engines—but are otherwise almost identical in construction, it may therefore be necessary to provide different filter systems that are each adapted to the air mass flow. Furthermore, the space available on the vehicle for the air filter system is usually limited, which can result in a compact and, in particular, flat design for the housing. In particular, the air intake opening may be comparatively small, which limits the air mass flow.

### SUMMARY

The present invention is concerned with the problem of providing an improved or at least a different design for an air filter system of the type described above, which is characterized in particular by increased flexibility with regard to its use for motor vehicles with different air mass flow rates or fresh air requirements.

The invention solves this problem with the scope of the independent claim(s). Advantageous embodiments are the scope of the dependent claim(s).

The invention is based on the general idea of equipping the housing of the air filter system with at least two air inlet openings, at least one of these multiple air inlet openings being closed by means of a removable cover. The maximum possible air mass flow rate of the air filter system, when the cover is removed, is defined by the two or more air intake openings, which can be gradually or stepwise reduced by attaching the respective cover. With exactly two air intake openings, two different air mass flows can thus be set, namely a smaller air mass flow when one air intake opening is closed with the cover and a larger air mass flow when the cover is removed so that both air intake openings are open. The same applies to three or more air inlets.

In detail, the invention requires that the housing is equipped with a housing base body that has at least two air inlet openings, through which the raw air to be filtered can flow into the housing interior, and an air outlet opening, through which the filtered clean air can flow out of the housing interior, wherein at least one of the at least two air inlet openings is closed by a cover which is detachably fastened to the housing base. The air intake openings can be configured flat so that they require little installation space.

The air filter system may be configured for an internal combustion engine or for a fuel cell system to filter air for operation of the internal combustion engine or fuel cell system, respectively.

The respective cover can be configured in such a way that the cover completely closes a cross-section of the respective air inlet opening that can be flowed through. This helps to prevent air leakage or leakage flow through the unneeded air inlet opening that is closed with the cover.

According to a favorable embodiment, the housing base body can have at least one opening frame that surrounds the respective air inlet opening. The respective cover can be arranged on the opening frame on an inner side of the frame facing the housing interior. This means that the cover is inaccessible from the outside of the casing and cannot be removed accidentally or arbitrarily from the outside. This improves the operational reliability of the air filter system.

It may be expedient to provide that the respective air inlet opening extends in a vertical direction and in a transverse direction perpendicular to the vertical direction, and that air can flow through it in a longitudinal direction perpendicular to the vertical and transverse directions when the cover is removed. In other words, the respective air inlet opening defines a local rectangular coordinate system. The housing base and the cover can now be configured and matched to each other in such a way that the cover can be assembled on the housing base to close the respective air inlet opening in an assembly direction parallel to the vertical direction. In other words, for assembly, the cover is moved in the assembly direction relative to the housing base. In the case of a housing base body that delimits the housing interior at the bottom in the vertical direction and is open at the top in the vertical direction, the cover can thus be inserted into the housing base body from above in order to close the respective air inlet opening. This results in an assembly that requires little installation space, making it comparatively easy to carry out.

In a favorable embodiment, the housing base body can have at least one first guide rib, which extends longitudinally in the vertical direction and projects in the longitudinal direction in the direction of the housing interior. For this purpose, the respective guide rib can be arranged or formed on an inner side of the base body facing the housing interior and can project in the longitudinal direction from the inner side of the base body, whereby it projects in the direction of the housing interior.

The cover can now have a first guide groove that complements the respective first guide rib, in which the respective first guide rib engages in the longitudinal direction and in which the respective first guide rib is held in the transverse direction in a form-fitting manner. As a result, the cover is held in a form-fitting manner in the transverse direction on the housing base body. The first guide rib and the first guide groove form a tongue and groove guide that is aligned parallel to the vertical direction and aligns the cover with the base body of the enclosure in the transverse direction. This simplifies the assembly.

In another advantageous embodiment, the housing base body can have at least one second guide rib on the inner side of the base body facing the housing interior, which extends longitudinally in the vertical direction and projects in the transverse direction from the inner side of the base body, the cover having a second guide groove which is complementary to the respective second guide rib and in which the respective second guide rib engages in the transverse direction and in which the respective second guide rib is held in a form-fitting manner in the longitudinal direction. As a result, the cover is held in a form-fitting manner in the longitudinal direction on the housing base body. The second guide rib forms a second tongue and groove guide with the second guide groove, which is aligned parallel to the horizontal direction and positions the cover in relation to the longitudinal direction relative to the housing base body. This measure also simplifies the assembly.

According to one embodiment, the housing base may have two vertical frame sections that extend in the vertical direction and that are located opposite each other in the transverse direction at the respective air inlet opening. Furthermore, two of the aforementioned second guide ribs can be provided, each located on one of these frame sections and projecting towards each other from the respective frame section in the transverse direction. The cover is thus positioned at its transverse ends facing away from each other in the transverse direction with respect to the longitudinal direction, whereby a clear alignment of the cover with respect to the housing base body in the longitudinal direction can be realized. This measure also simplifies the assembly.

According to another advantageous embodiment, the housing base body can have two horizontal frame sections that extend in the transverse direction and that are located opposite each other in the vertical direction at the respective air inlet opening. It makes sense for the first guide rib to connect the two horizontal frame sections. Thus, the first guide rib of the two vertical frame sections in the transverse direction is removed or arranged between the two vertical frame sections. This allows the cover to be aligned precisely with the housing base in the transverse direction. Furthermore, the first guide rib stiffens the opening frame when it connects the two horizontal frame sections to each other and is thereby supported on both horizontal frame sections. This means that the first guide rib extends in the vertical direction, so to speak, through the respective air intake opening.

In the case of appropriate further training, it may be stipulated that an air-guiding element is formed on the first guide rib on the outer side facing away from the housing interior, which, when the cover is removed, guides, or directs a raw-side air flow through the respective air inlet opening.

It may be expedient to provide two or more such first guide ribs, which are spaced apart in the transverse direction and each extend through the respective air intake opening.

According to another advantageous embodiment, the housing base body can have at least one positioning rib on the inner side of the base body, which projects in the vertical direction against the assembly direction from the inner side of the base body. The respective positioning rib can be configured so that the cover rests against the respective positioning rib in the longitudinal direction on the inner side of the cover facing the housing interior. This means that the cover is also positioned in the longitudinal direction between its transverse ends at its lower end, which was ahead during assembly.

According to an appropriate embodiment, the respective positioning rib can be arranged in the area of the respective first guide rib with respect to the transverse direction. In particular, two or more such positioning ribs may be provided. It may be practical to use the same number of positioning ribs as first guide ribs.

In another advantageous embodiment, a latching connection can be formed between the housing base and the cover, which is configured in such a way that, when the cover is moved in the assembly direction for the assembly on the housing base body, it latches in a predetermined assembly position of the cover, which closes the respective air inlet opening, and secures the cover against movement counter to the assembly direction, in particular in a form-fitting manner. In other words, as soon as the predetermined assembly position is reached when assembling the cover, the latching connection latches and secures the cover to the enclosure base body. This effectively prevents the cover from coming loose on its own, for example during operation of the air filter system in the motor vehicle and/or during further handling of the air filter system, for example when assembling the air filter system and/or installing it in the motor vehicle.

In a favorable embodiment, the latching connection can be configured so that it audibly engages when the cover is assembled at the assembly position. In other words, the latching connection engages when the cover is assembled, reaching the assembly position in such a way that it produces an audible sound, which represents an acoustic feedback for the respective assembler (male/female/diverse) and signals to the assembler that the desired assembly position has been reached. This measure also simplifies the assembly of the cover.

In a favorable embodiment, the latching connection can have a latching hook that is formed on the cover and is configured to be spring-elastic in the longitudinal direction. Furthermore, the latching connection can have a latching contour that is formed on the respective air inlet opening on a frame section of the housing base body that extends in the transverse direction. The latching hook and the latching contour can now be suitably matched or configured so that the latching hook engages on the latching contour when the cover is assembled when it reaches the assembly position. In other words, when assembled, the latching hook engages behind the latching contour or the latching hook is in form-fitting engagement with the latching contour.

In the case of favorable further training, the latching contour can have a latch opening in which an end section of the latch hook engages in the assembly position in a form-fitting manner. This increases the security against an arbitrary or inadvertent loosening of the latching connection.

It is advantageous for the latch opening to be open in the vertical direction so that the end section of the latching hook engages in the latch opening in the assembly position in the vertical direction opposite to the assembly direction. To remove the cover, it must be moved in the opposite direction to the assembly direction relative to the base body of the enclosure. When the latching connection is engaged, this causes the end section of the latching hook to be driven further into the latch opening, so that it is not possible to remove the cover when the latching connection is engaged without damaging the latching connection or the cover and/or the housing base body.

The end section of the latching hook that engages in the latch opening provides a form-fitting securing of the end section perpendicular to the direction of engagement and thus in particular perpendicular to the vertical direction. This makes it more difficult for the latching connection to come loose on its own or unintentionally.

The latching connection is conveniently arranged or assigned at a downstream end of the cover with respect to the assembly direction during assembly. At this point, there is sufficient space inside the housing for the latching connection without affecting the inner side of the base body. In particular, this helps to avoid unwanted flow obstacles that could interfere with the use of the air inlet opening that can be covered with the cover when the cover is removed.

The cover can advantageously have a cover body which can preferably be configured in a plate-like manner and can extend in particular in a plate plane running parallel to the vertical direction and parallel to the transverse direction and whose thickness or thickness direction runs parallel to the longitudinal direction. The latching hook can be configured in an S-shape in the longitudinal direction. In particular, the latching hook may have a U-shaped spring bracket that is open in the assembly direction and connected to the plate body. The latching hook can also have a U-shaped latching bracket that is open against the assembly direction and connects the end section to the spring bracket. The S-shaped configuration and the two U-shaped brackets or sections of the latching hook give it a comparatively high degree of elasticity in the longitudinal direction. This also results in spring elasticity in the vertical direction. The U-shaped design of the latching bracket allows the end section to enclose the edge of the latch opening and ultimately to engage in the latch opening against the assembly direction.

Conveniently, the housing base body can be open upwards in the vertical direction and have a housing base, which delimits the housing interior downwards in the vertical direction, and a housing wall, which laterally delimits the housing interior transversely to the vertical direction and which contains the air inlet openings and the air outlet opening. In addition, the housing can have a housing cover that is detachably attached to the housing base and closes the housing base from above. This means that the housing cover limits the housing interior upwards in the vertical direction. An air filter element can be arranged in the housing interior in such a way that it separates a raw chamber, which is fluidically connected to the air inlet openings, from a clean chamber, which is fluidically connected to the air outlet opening. The air filter element allows air to pass from the raw chamber to the clean chamber. The air filter element filters the air so that the raw air supplied via the raw chamber is filtered and cleaned and flows into the clean chamber as clean air.

The air filter element may comprise a U-shaped filter body made of filter material.

It is practical for the first guide grooves to be formed on an outer side of the cover that faces away from the housing interior. In particular, two webs running parallel to the vertical direction can be formed on the outside of the cover, which project in the longitudinal direction of the cover. The respective first guide groove is formed in the transverse direction between the two webs, namely by a gap between the two webs.

The cover body can have a collar that protrudes in the longitudinal direction at the edge, which can in particular run all the way around the cover body, closed, along the edge. Furthermore, the cover can be configured so that the collar rests against the upper horizontal frame section in the longitudinal direction. In addition, the collar can have a recess for each respective latch hook and/or for each respective first guide slot.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in:

FIG. 1 is an isometric view of an air filter system with a housing base, air filter element and cover.

FIG. 2 shows an isometric view of the air filter system with a housing cover,

FIG. 3 shows an exploded isometric view of the basic housing with the cover,

FIG. 4 is another isometric view of the housing base with the cover,

FIG. 5 shows a view in the longitudinal direction of the base body of the enclosure in the area of the cover,

FIG. 6 shows a view in the vertical direction of the base body of the enclosure in the area of the cover,

FIG. 7 shows an isometric view of the base body of the housing in the area of the cover,

FIG. 8 shows an isometric sectional view in the area of a latching connection corresponding to the sectional lines VIII in FIG. 6,

FIG. 9 shows an isometric sectional view in the area of a first guide rib corresponding to the sectional lines IX in FIG. 6.

### DETAILED DESCRIPTION

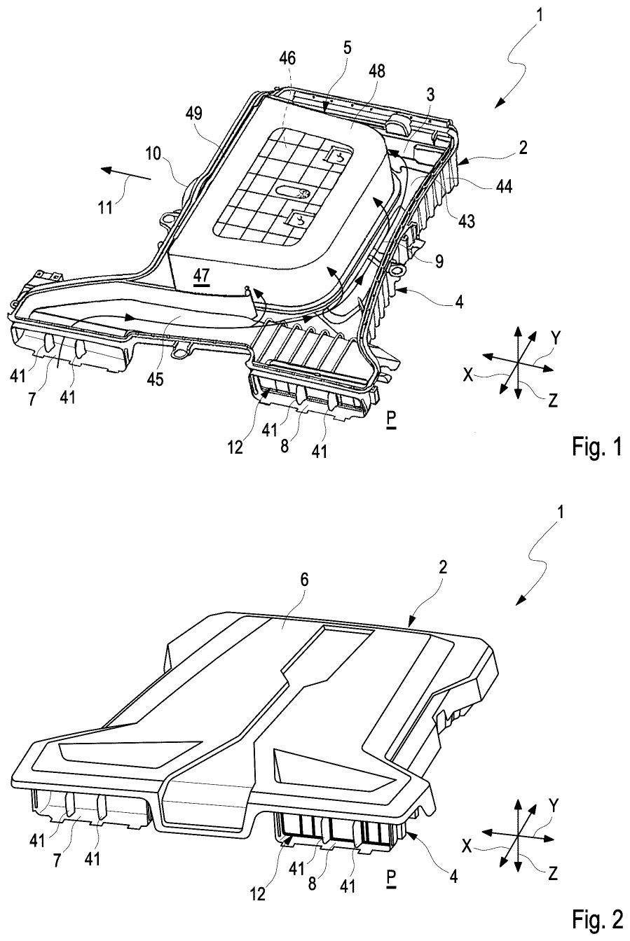

According to FIGS. 1 through 4, an air filter system 1 comprises a housing 2 having a housing interior 3 and a housing base body 4. An air filter element 5 is arranged in the housing interior 3 as shown in FIG. 1. As shown in FIG. 2, the housing 2 can also have a housing cover 6 that is fixed to the housing base 4 when assembled.

The housing base body 4 has at least two air intake openings 7, 8, through which the raw air 9 to be filtered can flow into the housing interior 3. The raw air 9 is indicated by arrows in FIG. 1. Furthermore, the housing base body 4 has an air outlet opening 10 through which the filtered clean air 11 can flow out of the housing interior 3. In FIG. 1, the clean air 11 is indicated by an arrow.

In the air filter system 1 shown here, at least one of the at least two air inlet openings 7, 8 can be closed or is closed by a cover 12, which is detachably attached to the housing base 4 for this purpose. In the preferred example shown here, the air filter system 1 has exactly two air inlet openings 7, 8, with only one of these two air inlet openings 7, 8 having such a cover 12 assigned to it. In the example of FIGS. 1 through 4, the one or first air inlet opening 7, which is located on the left in FIGS. 1 through 4, is permanently open, while the other or second air inlet opening 8, which is located on the right in FIGS. 1 through 4, can be closed using the cover 12. If the second air inlet opening 8 is not required for a particular application of the air filter system 1, it can be closed with the cover 12 and thus deactivated. If, on the other hand, the second air inlet opening 8 is also required for a different application of the air filter system 1, the cover 12 can be removed so that the second air inlet opening 8 is then open and, like the first air inlet opening 7, is available for supplying raw air. This means that different air mass flows can be realized with the help of the air filter system 1.

In another embodiment, not shown, the cover 12 can also be configured so that it can be used to close the first air inlet opening 7. However, the embodiment shown here is preferred, in which the second air inlet opening 8 can be closed using the cover 12. In this case, a larger, longer flow path for the raw air is available for the first air inlet opening 7 in the housing interior 3, which brings acoustic advantages during the operation of the air filter system 1.

The following describes the cover 12 in more detail, using FIGS. 1 through 9. It can be seen that the cover 12 can be configured and dimensioned in such a way that it completely closes a cross section of the respective air inlet opening 8 that can be flowed through. Thus, the cover 12 is essentially configured complementary to the cross-section of the associated air inlet opening 8 through which air can flow.

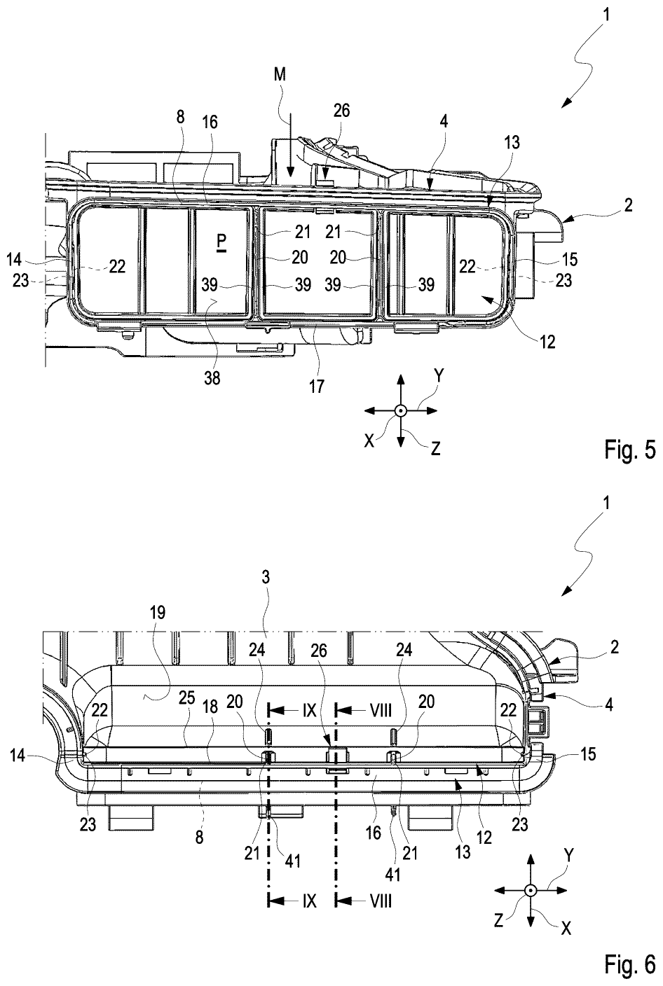

As shown in FIGS. 5 through 9, the housing base body 4 can have an opening frame 13 for each air inlet opening 8, which surrounds the respective air inlet opening 8. For this purpose, the opening frame 13, which is essentially rectangular, can have two vertical frame sections 14, 15 and two horizontal frame sections 16, 17. In any case, the cover 12 can be arranged on the opening frame 13 on a frame inner side 18 facing the housing interior 3. This means that the cover 12 is located in the housing interior 3 or forms a boundary of the housing interior 3.

The respective air inlet opening 8 defines a longitudinal direction X, a transverse direction Y and a vertical direction Z, which are perpendicular to one another. The air inlet opening 8 extends in the vertical direction Z and in the transverse direction Y and is thus located in an opening plane. When the cover 12 is removed, air can flow through the air inlet opening 8 in the longitudinal direction X. In FIG. 5, the longitudinal direction X is perpendicular to the drawing plane. In FIG. 6, the vertical direction Z is perpendicular to the drawing plane.

In the example shown, the two air inlet openings 7, 8 are spaced apart in the transverse direction Y and can otherwise be configured identically, preferably mirror-symmetrically. In particular, both air intake openings can extend in the opening plane defined by the vertical direction and the transverse direction.

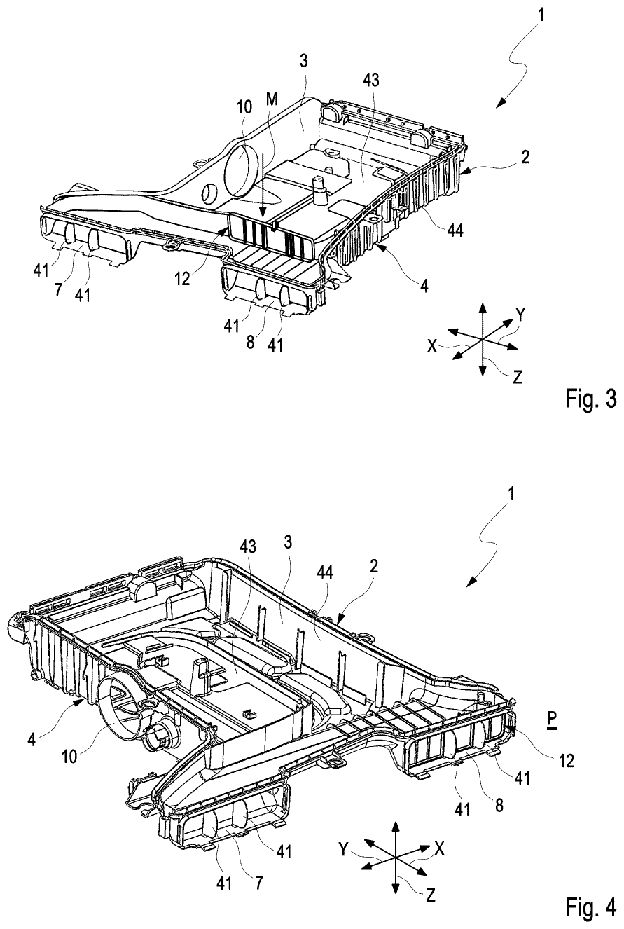

The housing base 4 and the cover 12 are designed to fit together in such a way that the cover 12 can be assembled on the housing base 4 in one assembly direction M to close the respective air inlet opening 8. The assembly direction M is indicated by an arrow in FIGS. 3, 5, 8, and 9 and runs parallel to the vertical direction Z. FIG. 3 shows the cover 12 during assembly, i.e., in a state in which the cover 12 is not yet attached to the housing base 4.

As shown in FIGS. 5 through 9, the housing base body 4 has, on a base body inner side 19 facing the housing interior 3, at least one first guide rib 20 which extends longitudinally in the vertical direction Z and projects in the longitudinal direction X from the base body inner side 19. The first guide rib 20 is located at the respective air inlet opening 8. In this area, the base body inner side 19 is formed only by the opening frame 13. In this respect, the first respective guide rib 20 on this opening frame 13 protrudes from the base body inner side 19 and from the frame inner side 18. In the example shown here, exactly two first guide ribs 20 are provided. It is clear that, in principle, only a single first rib 20 of the neck can be present. Likewise, three or more such first guide ribs 20 can be provided. In any case, the cover 12 has a complementary first guide groove 21 for each first guide rib 20, but at least for one such first guide rib 20. In the example shown, two such first guide grooves 21 are provided. The first guide rib 20 engages in the longitudinal direction X in the associated first guide groove 21 and is held in it in the transverse direction Y in a form-fitting manner. This means that the cover 12 on the basic housing body 4 is held in a form-fitting manner in the transverse direction Y by the form-fitting engagement between the first guide ribs 20 and the first guide grooves 21.

In the preferred embodiment shown here, the housing base body 4 also has at least one second guide rib 22 on the base body inner side 19, which extends longitudinally in the vertical direction Z and in doing so projects from the base body inner side 19 in the transverse direction Y. In the example shown here, there are exactly two such second guide ribs 22. In principle, an embodiment with only a single such second guide rib 22 is conceivable. In any case, the cover 12 is equipped with a complementary second guide groove 23 for every second guide rib, but at least for one such second guide rib 22. In the example shown, the cover 12 has exactly two such second guide grooves 23. The second guide rib 22 engages in the second guide groove 23 in the transverse direction Y and is held in it in the longitudinal direction X in a form-fitting manner. As a result, the cover 12 is held on the housing base 4 in the longitudinal direction X by the form-fitting engagement between the second guide ribs 22 and the second guide grooves 23.

In the rectangular configuration of the respective air inlet opening 8 shown here, the two vertical frame sections 14, 15 extend essentially parallel to the vertical direction Z and are located opposite each other at the air inlet opening 8 with respect to the transverse direction Y. The two second guide ribs 22 provided here are each arranged on one of these two vertical frame sections 14, 15, with the two guide ribs 22 projecting towards each other from the respective vertical frame sections 14, 15 in the transverse direction Y.

In the rectangular configuration of the air inlet opening 8 shown here, the two horizontal frame sections 16, 17 extend essentially parallel to the transverse direction Y and are located opposite each other in the vertical direction Z at the air inlet opening 8. The first respective leading rib 21 is configured here to connect the two horizontal frame sections 16, 17. The respective first guide rib 21 of the two vertical frame sections 14, 15 is spaced in the transverse direction Y. The first two or more guide ribs 21 are spaced apart from each other and from the two vertical frame sections 14, 15 in the transverse direction Y.

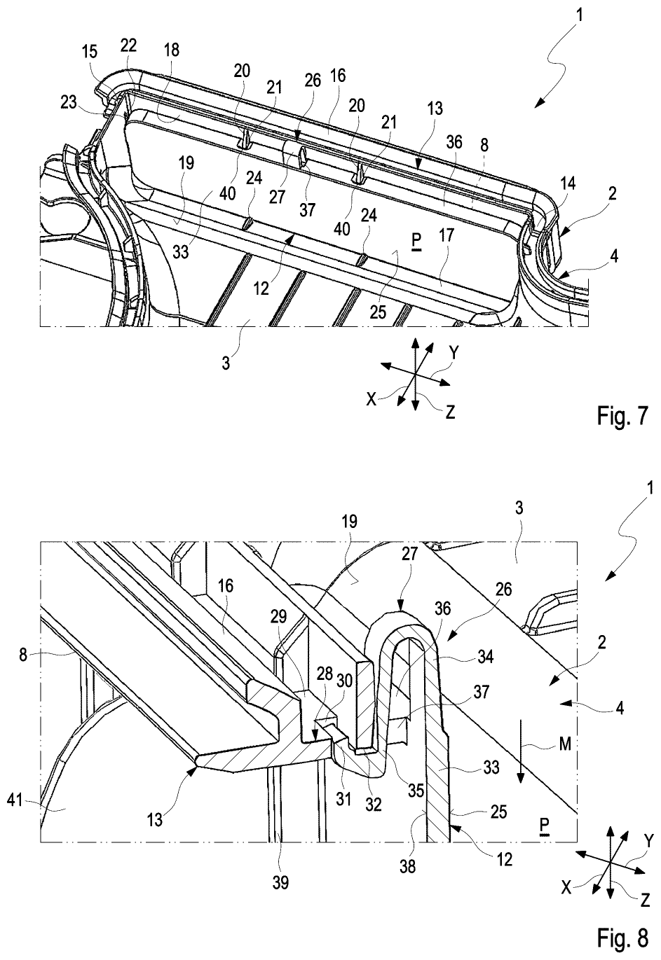

According to FIGS. 6 and 7, the housing base body 4 can have at least one positioning rib 24 on its base body inner side 19, which projects in the vertical direction Z against the assembly direction M from the base body inner side 19. With the orientation of the housing 2 shown in the figures, the assembly direction M is oriented from top to bottom. Accordingly, the respective positioning rib 24 protrudes from the base body inner side 19 from bottom to top. The cover 12 is dimensioned so that the cover's inner side 25 facing the housing interior 3 rests against the respective positioning rib 24 in the longitudinal direction X. In the example shown, exactly two such positioning ribs 24 are provided. These are positioned at a distance from each other in the transverse direction Y and at a distance from the two vertical frame sections 14, 15 in the transverse direction Y. Preferably, there are as many positioning ribs 24 as there are first guide ribs 20. In particular, it may be provided that the respective positioning rib 24 is arranged in the area of one of the first guide ribs 20 with respect to the transverse direction Y. In the example shown here, both positioning ribs 24 are each arranged in the area of one of the first guide ribs 21.

In the example shown here, the air filter system 1 is also equipped with a latching connection 26 that is used to latch the cover 12 to the basic housing 4. This ultimately forms the latching connection 26 between the housing base 4 and the cover 12. This latching connection 26 is configured in such a way that, when the cover 12 is moved in the assembly direction M to assemble it on the housing base body 4, it latches into a predetermined assembly position P that closes the respective air inlet opening 8. This assembly position P is shown in FIGS. 1, 2, and 4 through 9. The snapped or latched latching connection 26 secures the cover 12 on the housing base body 4 against movement against the assembly direction M. This securing is achieved in particular by means of a form fit. The latching connection 26 can be configured in such a way that it audibly engages when the cover 12 is assembled at the assembly position 12. When the cover 12 is manually assembled, the latching connection 26 thus makes an audible sound when it reaches the assembly position P, which acoustically indicates to the respective technician that the assembly position P has been reached as desired.

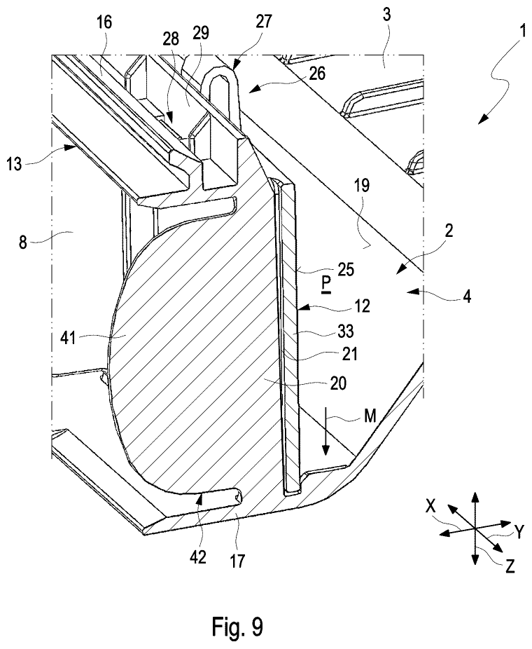

As shown in FIG. 8, the latching connection 26 can have a latching hook 27 formed on the cover 12, which is configured to be spring-elastic in the longitudinal direction X. In addition, the latching connection 26 can have a latching contour 28 which is formed on the respective air inlet opening 8 on a frame section 29 of the housing base body 2 that extends in the transverse direction Y. In the example shown here, this frame section 29 is formed by an area of one horizontal frame section 16, 17, namely by the upper horizontal frame section 16 in FIG. 5, past which the cover is first moved during assembly. The latching hook 27 and the latching contour 28 are aligned with each other in such a way that the latching hook 27 latches onto the latching contour 28 when the assembly position P is reached when assembling the cover 12.

In the example shown here, the latching contour 28 has a latch opening 30 in which an end section 31 of the latching hook 27 engages in a form-fitting manner when the assembly position P is reached. In the example shown, the latch opening 30 is open in the vertical direction Z. FIGS. 6 and 8 show that the latch opening 30 is configured as a through-opening here. In principle, however, a latch opening 30 that is only open at the bottom, i.e., in the assembly direction M or towards the respective air inlet opening 8, may suffice. The latching hook 27 can now be configured so that the end section 31 of the latch hook 27 engages in the latch opening 30 in the vertical direction Z when it reaches the assembly position P, against the assembly direction M. In the figures, the assembly direction M is oriented from top to bottom. Accordingly, the end section 31 engages from below in the latch opening 30 from bottom to top as shown in FIG. 8. The latch opening 30 can be configured such that it is enclosed all around by an opening edge 32, as shown in FIG. 8. The end section 31 that engages in the latch opening 30 is thereby secured by this opening edge 32 in a manner that is transverse to the vertical direction Z, and thus in particular in the longitudinal direction X and in the transverse direction Y, in a form-fitting manner.

In the example shown here, the cover 12 can have a plate-shaped cover body 33. In particular, the cover body 33 can be configured to be flat, with its plate plane extending parallel to the vertical direction Z and parallel to the transverse direction Y. One direction of thickness of the cover body 33 extends parallel to the longitudinal direction X. The latching hook 27 can, according to FIG. 8, have a U-shaped spring bracket 34, which is open in the assembly direction M, thus downwards in FIG. 8, and which is connected to the cover body 33. In addition, the latching hook 27 has, in contrast to the assembly direction M, an upwardly open U-shaped latching bracket 35 as shown in FIG. 8, which connects the end section 31 to the spring bracket 34. The two open brackets in the vertical direction Z, namely the spring bracket 34 and the latching bracket 35, give the latching hook 37 an S-shaped design in the longitudinal direction X and give it comparatively high spring elasticity in the longitudinal direction X. At the same time, a certain spring elasticity is also realized in the vertical direction Z. This allows the latching hook 27 to grasp the opening edge 32 when it reaches the assembly position P and to engage in the latch opening 30 in the vertical direction Z, against the assembly direction M.

To remove or dismount the cover 12, the latching connection 26 must first be released. In this case, the latching hook 27 must be disconnected from the latching contour 28 and the end section 31 must be removed from the latch opening 30. This can be done, for example, by using a tool to push the end section 31 out of the latch opening 30 in the assembly direction M in the case of the latch opening 30 designed as a through-opening.

In the example shown, the cover 12 also has a collar 36 that is arranged on the edge and projects from the cover body 33 in the longitudinal direction X, which, in particular, can run around the cover body 33 in a largely closed manner. In the area of the latching connection 26, the collar 36 has a recess 37 in which the latching hook 27 is formed. In the assembly position P, the cover 12 is supported in the longitudinal direction X by the collar 36, at least on the upper horizontal frame section 16.

In the example shown here, the first guide grooves 21 are formed on a cover's outer side 38 facing away from the housing interior 3 with the aid of two webs 39 in each case, which extend longitudinally in the vertical direction Z and project from the cover's outer side 38 in the longitudinal direction X. The two webs 39, which are assigned to the respective first guide groove 21, are spaced apart from one another in the transverse direction Y, so as to form the respective first guide groove 21 between them. It is advantageous if these webs 29 extend over the entire height of the cover 12 and can end in particular at the peripheral collar 36, which can have a further interruption 40 in the area of each respective first guide groove 21, so that the respective first guide rib 20 can project in the vertical direction Z over the cover 12. This is particularly evident in FIG. 7.

According to FIGS. 1 through 4, the housing base body 4 can have 7, 8 air guide elements 41 in the area of the respective air inlet opening, which align the air flow at the respective air inlet opening 7, 8 when the air filter system 1 is in operation. As can be seen in particular from FIG. 9, these air guide elements 41 can be formed on the first guide ribs 20 at the air inlet opening 8, which can be closed by the cover 12. In other words, according to FIG. 9, a web-shaped section 42 is formed in the respective air inlet opening 8 on the housing base body 4, which forms the respective first guide rib 20 on its inner side facing the housing interior 3, while it forms the respective air guide element 41 on its outer side facing away from the housing interior 3.

According to FIGS. 1 through 4, the housing base body 4 is open at the top in the vertical direction Z and forms a housing base 43 and a housing wall 44. The housing base 43 limits the housing interior 3 in the vertical direction Z at the bottom. The housing wall 44 laterally bounds the housing interior 3 transversely to the vertical direction Z. The housing wall 44 also contains the two air inlet openings 7, 8 and the air outlet opening 10. The housing cover 6 is detachably attached to the housing base 4 and closes the housing base 4 from above. The housing cover 6 thus limits the housing interior 3 in the vertical direction Z at the top.

The air filter element 5 arranged in the housing interior 3 in accordance with FIG. 1 separates a raw chamber 45, which is fluidically connected to the air inlet openings 7, 8, from a clean chamber 46, which is fluidically connected to the air outlet opening 10, in the housing interior 3. When the air filter system 1 is in operation, air can flow through the air filter element 5, whereby the air flows from the raw chamber 45 to the clean chamber 46. In the example shown in FIG. 1, the air filter element 5 is equipped with a U-shaped filter body 47, which consists of a filter material and allows air to flow through it. The filter body 47 is sealed in the vertical direction Z by two end plates 48, of which only the upper end plate 48 facing the observer is visible in FIG. 1. The U-shaped filter body 47 ends at an end plate 49, which has a filter outlet opening not shown here, which is fluidically connected to the air outlet opening. The raw chamber 46 is formed inside the air filter element 5, which is bounded in the vertical direction Z by the two end plates 48 and transversely to the vertical direction Z by the front plate 49 and the filter body 47.

The relative locations “top” and “bottom” refer to the vertical direction Z and are defined by the assembly direction M, which extends parallel to the vertical direction Z and is oriented from top to bottom.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. An air filter system of a motor vehicle, comprising:
a housing including i) a housing interior for receiving an air filter element and ii) a housing base body; and
a cover detachably fastened to the housing base body;
the housing base body including:
at least two air inlet openings through which raw air to be filtered is flowable into the housing interior; and
an air outlet opening through which filtered, clean air is flowable out of the housing interior;
wherein at least one air inlet opening of the at least two air inlet openings is closable via the cover.

2. The air filter system according to claim 1, wherein:
the housing base body further includes at least one opening frame bordering the at least one air inlet opening all around; and
the cover is arranged on the at least one opening frame on a frame inner side facing the housing interior.

3. The air filter system according to claim 1, wherein:
the at least one air inlet opening extends in a vertical direction and in a transverse direction extending perpendicular to the vertical direction;
when the cover is removed, air is flowable through the at least one air inlet opening in a longitudinal direction extending perpendicular to the vertical direction and perpendicular to the transverse direction; and
the housing base body and the cover are configured such that the cover is assemblable on the housing base body in an assembly direction extending parallel to the vertical direction to close the at least one air inlet opening.

4. The air filter system according to claim 3, wherein:
the housing base body further includes at least one first guide rib on the at least one air inlet opening on a base body inner side facing the housing interior, the at least one first guide rib extending longitudinally in the vertical direction and projecting in the longitudinal direction from the base body inner side; and
the cover includes a first guide groove complementary to the at least one first guide rib, the first guide groove engaging the at least one first guide rib in the longitudinal direction and holding the at least one first guide rib in a form-fitting manner in the transverse direction.

5. The air filter system according to claim 4, wherein:
the housing base body further includes, on the base body inner side facing the housing interior, at least one second guide rib extending longitudinally in the vertical direction and projecting in the transverse direction from the base body inner side; and
the cover further includes a second guide groove complementary to the at least one second guide rib, the second guide groove engaging the at least one second guide rib in the transverse direction and holding the at least one second guide rib in a form-fitting manner in the longitudinal direction.

6. The air filter system according to claim 5, wherein:
the housing base body further includes two vertical frame sections extending in the vertical direction and arranged opposite each other in the transverse direction at the at least one air inlet opening; and
the at least one second guide rib includes two second guide ribs each arranged on a respective vertical frame section of the two vertical frame sections and projecting towards each other from the respective vertical frame section in the transverse direction.

7. The air filter system according to claim 4, wherein:
the housing base body further includes two horizontal frame sections extending in the transverse direction and arranged opposite each other in the vertical direction at the at least one air inlet opening; and
the at least one first guide rib connects the two horizontal frame sections to each other.

8. The air filter system according to claim 3, wherein:
the housing base body further includes, on a base body inner side, at least one positioning rib projecting in the vertical direction against the assembly direction from the base body inner side; and
an inner side of the cover facing the housing interior rests against the at least one positioning rib in the longitudinal direction.

9. The air filter system according to claim 3, further comprising a latching connection between the housing base body and the cover, the latching connection configured such that, when the cover is moved in the assembly direction for assembling on the housing base body, the latching connection latches in a predetermined assembly position of the cover in which the cover closes the at least one air inlet opening and secures the cover against movement counter to the assembly direction.

10. The air filter system according to claim 9, wherein the latching connection is configured to audibly engage when the cover is assembled at the predetermined assembly position.

11. The air filter system according to claim 9, wherein:
the latching connection includes a latching hook arranged on the cover, the latching hook configured in the longitudinal direction in a spring-elastic manner;
the latching connection further includes a latching contour arranged on the at least one air inlet opening on a frame section of the housing base body that extends in the transverse direction; and
the latching hook engages with the latching contour when the assembly position is reached when assembling the cover on the housing base body.

12. The air filter system according to claim 11, wherein the latching contour includes a latch opening in which an end section of the latching hook engages in a form-fitting manner when in the assembly position.

13. The air filter system according to claim 12, wherein:
the latch opening is open in the vertical direction; and
the end section of the latching hook engages in the assembly position in the vertical direction against the assembly direction in the latch opening.

14. The air filter system according to claim 12, wherein:
the cover includes a cover body;
the latching hook includes a U-shaped spring bracket which is open in the assembly direction and is connected to the cover body; and
the latching hook further includes a U-shaped latching bracket which is open against the assembly direction and connects the end section of the latching hook to the spring bracket.

15. The air filter system according to claim 1, wherein:
the housing base body is open at a top in a vertical direction;
the housing base body further includes a housing base delimiting the housing interior at a bottom in the vertical direction;
the housing base body further includes a housing wall delimiting the housing interior laterally transversely to the vertical direction, the housing wall including the at least two air inlet openings and the air outlet opening;
the housing further includes a housing cover detachably attached to the housing base and closing the housing base from above; and
the air filter element is arrangeable in the housing interior such that the air filter element separates a raw chamber, which is fluidically connected to the at least two air inlet openings, from a clean chamber, which is fluidically connected to the air outlet opening, and air is flowable through the air filter element.

16. An air filter system of a motor vehicle, comprising:
a housing including a housing base body, the housing base body at least partially defining a housing interior configured to receive an air filter element; and
a cover detachably connected to the housing base body via a latching connection;
the housing base body including:
a housing base defining a bottom of the housing base body;
a housing wall projecting transversely from the housing base;
a plurality of air inlet openings through which raw air to be filtered is flowable into the housing interior; and
an air outlet opening through which filtered, clean air is flowable out of the housing interior;
wherein the plurality of air inlet openings and the air outlet opening are disposed in the housing wall;
wherein an air inlet opening of the plurality of air inlet openings is closable via the cover; and
wherein the cover is connectable to the housing base body in an assembly direction, which extends transversely to a throughflow direction of the air inlet opening.

17. The air filter system according to claim 16, wherein the housing base body further includes a plurality of opening frames that each extend around a perimeter of a respective air inlet opening of the plurality of air inlet openings.

18. The air filter system according to claim 16, wherein:
the housing base body further includes:
a first guide rib disposed on a first interior surface of the housing base body facing in the throughflow direction, the first guide rib projecting from the first interior surface in the throughflow direction and extending along the first interior surface parallel to the assembly direction; and
a second guide rib disposed on a second interior surface of the housing base body facing in a transverse direction extending transversely to the throughflow direction and to the assembly direction, the second guide rib projecting from the second interior surface in the transverse direction and extending along the second interior surface parallel to the assembly direction; and
the cover includes:
a first guide groove structured and arranged to receive the first guide rib; and
a second guide groove structured and arranged to receive the second guide rib.

19. The air filter system according to claim 18, wherein:
the housing base body further includes a positioning rib disposed on a third interior surface of the housing base body facing opposite the assembly direction, the positioning rib arranged spaced apart from the first interior surface of the housing base body in the throughflow direction; and
a portion of the cover is disposed between the first interior surface of the housing base body and the positioning rib relative to the throughflow direction.

20. The air filter system according to claim 19, wherein:
the cover further includes a latching hook that is elastically deflectable in the throughflow direction;
the housing base body further includes a latching contour configured to releasably engage the latching hook; and
the latching hook and the latching contour collectively define the latching connection via which the cover is detachably connected to the housing base body.
